(19) United States
(12) Patent Application Publication
(10) Pub. No.: US 2003/0135644 A1
(43) Pub. Date: Jul. 17, 2003

(54) Method for determining network paths

(76) Inventor: Mark A Barrett, Ipswich (GB)

Correspondence Address: Nixon & Vanderhye, 8th Floor, 1100 North Glebe Road, Arlington, VA, 22201-4714, US

(21) Appl. No.: 10/220,429

(22) PCT Filed: Jan. 24, 2001
(86) PCT No.: PCT/GB01/00283

(30) Foreign Application Priority Data
Mar. 31, 2000 (EP) 00302740.6

(51) Int. Cl. G06F 15/173

(52) U.S. Cl. 709/238

(57) ABSTRACT

A method of determining one or more paths through a communications network, which one or more paths are arranged to transmit data between at least one transmitting node and at least one receiving node, the method comprising the steps of:

(i) identifying a first network forwarding node that is in operative association with the transmitting node;

(ii) for each port of the first network forwarding node, determining a network address of a second network forwarding node to which the data has passed; repeating step (ii) for each of the second and subsequently so determined network forwarding nodes, until a network forwarding node is determined to be directly connected to the at least one receiving node.

This invention relates to a method of determining network paths, and is suitable particularly, but not exclusively, for determining the delivery path(s) for multicast traffic.

Data can be transmitted over networks as either unicast or multicast packets. Typically, unicast is used when data is to be sent to, and from, a single receiver, whereas multicast is used when the same data is sent from a single content provider to multiple receivers—for example music, video data—which many people may be interested in receiving. For unicast, the receiver's network address must be known, as routers use the “destination” address of packets to make forwarding decisions. However, for multicast forwarding, routers use the “source” address for forwarding decisions, and the network address of the receivers is unknown. Multicast forwarding, as defined in Request for Comments (RFC) 1112 (published by the Internet Engineering Task Force (IETF) (available from http://www.ietf.org)), is based upon Internet Protocol version 4 (lPv4) class D address space, and this is used in the destination field of the IP header. (It will be understood that in Class D address space, the first four bits containing 110 identifies an address as a multicast. Multicast addresses range from 224.0.0.0 to 239.255.255.255).

Several multicast protocols have been developed to distribute traffic from the content provider to these many receivers. For example: Multicast extension to Open Shortest Path First (MOSPF), which uses an extension to the Open Shortest Path First (OSPF) link state mechanism; Protocol Independent Multicast (PIM), which uses existing unicast routing tables plus join/prune/graft; and Distance Vector Multicast Routing Protocol (DVMRP) which uses its own DVMRP Routing table (a customised Routing Information Protocol (RIP) table) plus a special Poison-Reverse mechanism. Further details of these protocols may be found, for example, in Multicast Networking and Applications by C. Kenneth Miller, Addison-Wesley Pub Co; ISBN: 0201309793. These various protocols operate different forwarding mechanisms, and this, together with the way in which receivers request data, namely using the Internet Group Messaging Protocol (IGMP), means that neither the location of receivers nor the path that multicast data has taken through the network is known.

Current methods of multicast network management require the network administrator to probe multicast devices using the equipment vendor's command line interface. Typically the administrator requests:

1) The incoming interface for the multicast stream;

2) The outgoing interfaces;

3) Directly connected receivers;

4) Which multicast routing protocols are used; and

5) Valid multicast routers that are located on the outgoing interfaces.

This process has to be repeated for every multicast router on the delivery process. Therefore, to achieve overall visibility of the multicast delivery path is a slow and difficult process requiring considerable knowledge of routers and routing protocols.

The Inter-Domain Multicast Routing Working Group has developed a “traceroute” tool, currently available as an internet-draft from either AT&T™ Research or Cisco™ Systems. This tool operates by tracing the route from receiver to source, passing packets through the network, with each router in the path adding information to the packet. Once the packet has reached the source, it is sent, using unicast, to the receiver's Internet Protocol (IP), or network, address. This tool therefore only traces one route for one receiver.

Unix functions mrtree, mtree and mtrace are utilities for gathering multicast tree information that is routed at a given router. In particular, mrtree can be used to discover both the actual and potential multicast trees for a given source that is multicasting to a given group and routed at a given router. The user is required to know information such as the multicast group address, the transmitting source and the receiving hosts. The program is run for each receiving host and the information from each host is collated in order to generate a total delivery path. These programs only work on Unix platforms and do not understand how Local Area Networks are managed (e.g. designated router per LAN). Therefore, as IP multicast routers will only keep information on one receiving host per interface (via IGMP) even if there are fifty receivers, it is impossible to determine the entire delivery path. In order to use these tools usefully, a high level of knowledge of a network topology, configuration and protocols is required. Moreover, mtree cannot be run from an end-host machine: IGMPv1 and IGMPv2 only understand requests for multicast group addresses—not requests to receive multicast traffic from a specific source. As the transmitting source address is one of the input parameters to mtree, this tool is only operable by network managers.

According to a first aspect of the present invention there is provided a method of determining one or more paths through a communications network, which one or more paths are arranged to transmit data between at least one transmitting node and at least one receiving node, the method comprising the steps of:

(i) identifying a first network forwarding node that is in operative association with the transmitting node;

(ii) for each port of the first network forwarding node, determining a network address of a second network forwarding node to which the data has passed; repeating step (ii) for each of the second and subsequently so determined network forwarding nodes, until a network forwarding node is determined to be directly connected to the at least one receiving node.

Preferably the data corresponds to a multicast group address, and the step of identifying a first network node comprises the steps of:

a) determining a network address of a predetermined network forwarding node, through which multicast data is registered;

b) obtaining a list of all nodes that are directly accessible via the predetermined network forwarding node;

c) determining whether the transmitting node is directly connected to the predetermined network forwarding node, and if so, assigning the predetermined network forwarding node to the first network forwarding node;

d) if not, identifying, from the list of directly accessible nodes, a next network forwarding node from which the transmitting node is accessible, and repeating steps b)—d) until the transmitting node is determined to be directly connected to the said next network forwarding node, and assigning the said next network forwarding node to the first network forwarding node

Conveniently the method further comprises the steps of:

a) obtaining a first list of network addresses of all nodes that are accessible via the said network forwarding node for each node listed in the first list:

a11) categorising the node;

a12) if the categorised node corresponds to a switch network node, obtaining a second list, which second list comprises addresses that are accessible via the categorised node;

a13) repeating steps a11-a12 until all switch nodes that are accessible via the said network forwarding node have been identified.

Further features of a method for determining network paths will now be described, by way of example only as an embodiment of the present invention, and with reference to the accompanying drawings, in which:

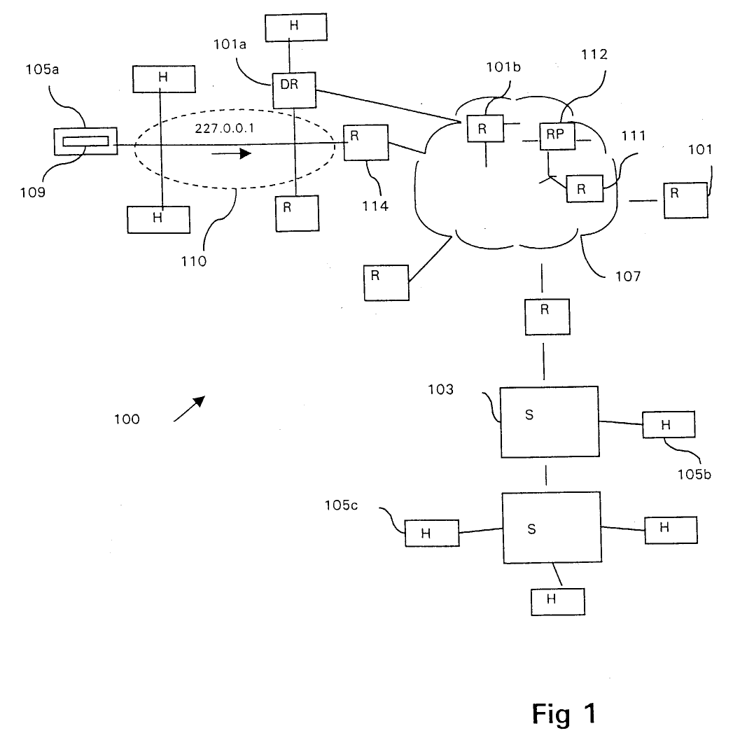

FIG. 1 is a schematic diagram of a network including network devices that are operable to receive multicast data;

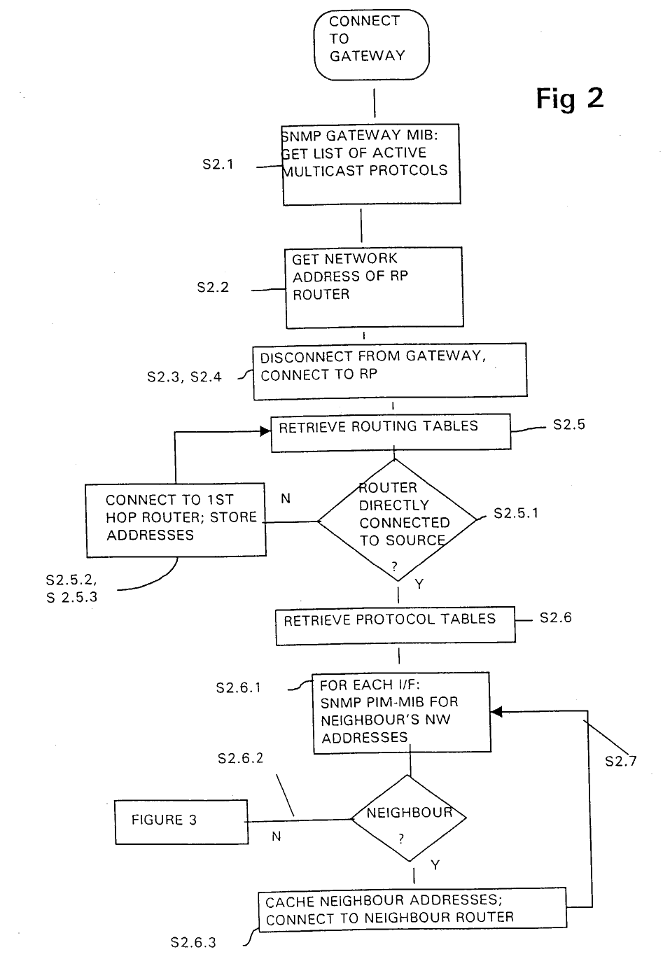

FIG. 2 is a schematic flow diagram describing a process of determining network paths according to the present invention;

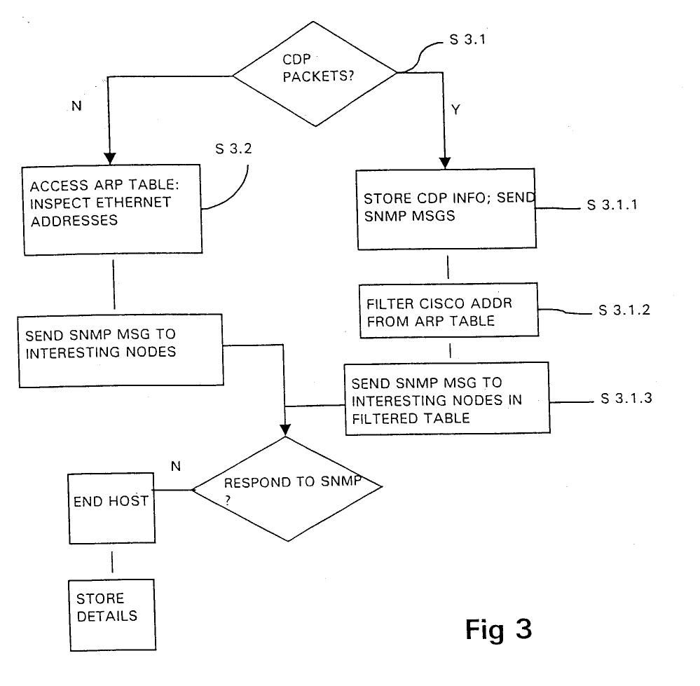

FIG. 3 is a schematic flow diagram describing a method for discovering non-multicast forwarding network nodes according to the present invention;

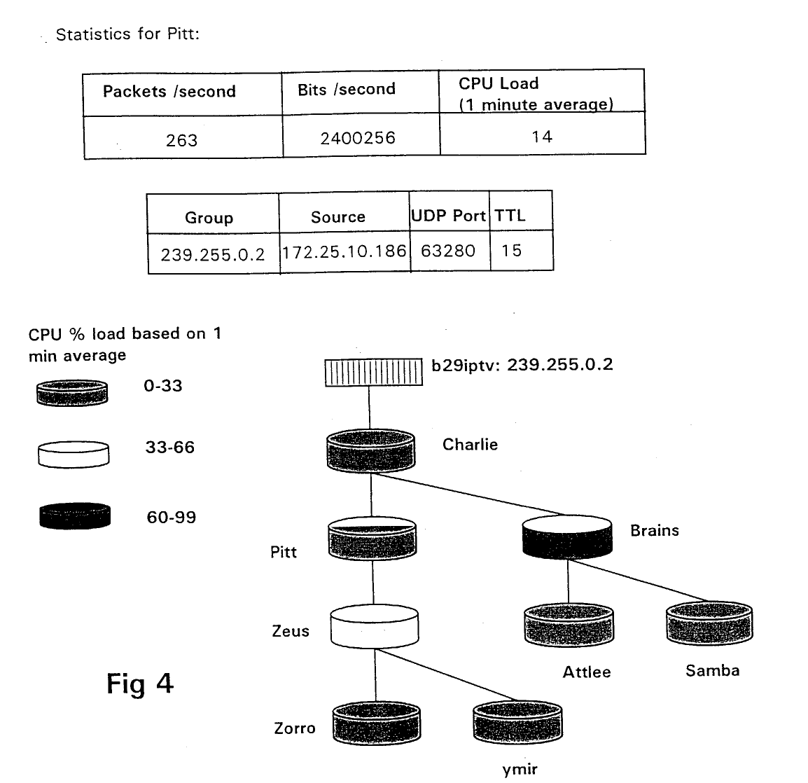

FIG. 4 is a typical output of the method shown in FIG. 2, showing routers comprising the multicast path; and

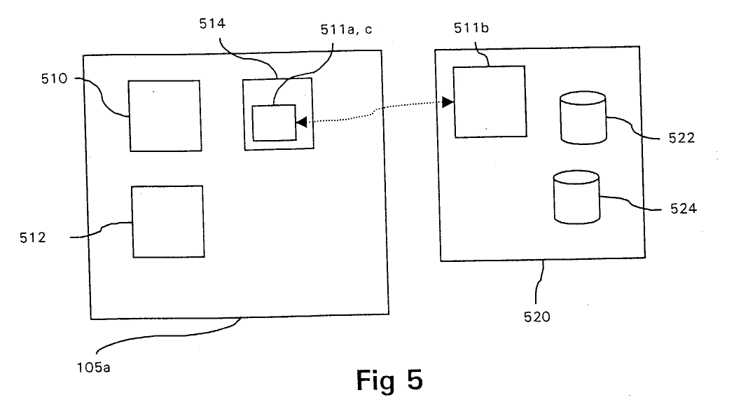

FIG. 5 is a schematic block diagram showing in greater detail the processes present in a client and server arrangement forming part of the embodiment of FIG. 1

In the following description, the terms “node”, “device”, “host”, “receiver” and “end host” are used. These are defined as follows:

“node”: any equipment that is attached to a network, including routers, switches, repeaters, hubs, clients, servers; the terms “node” and “device” are used interchangeably;

“host”: equipment for processing applications, which equipment could be either server or client, and may also include a firewall machine. The terms host and end host are used interchangeably; and

“receiver”: host that is receiving multicast packets (IP datagrams, ATM cells etc.).

Overview

FIG. 1 shows a generally conventional arrangement of a network 100, specifically an Ethernet type of network, comprising routers 101, switches 103 and hosts 105, interconnecting with a network 107 (only one of each type of nodes has been labelled in FIG. 1 for clarity). Nodes each have a physical address, or identifier, which identifies the node itself, and a network address identifying where it is in the network. In a conventional manner, the routers 101 make decisions of whether and where to forward packets that it receives on any of its interfaces based on the network address of the destination of the packet, modifying the physical address of the packet if required. Switches 103 interconnect multiple Ethernets, simultaneously transmitting multiple packets, without modifying the packet, and hosts 105 are either client or server machines (including database servers, web servers, proxy servers etc.) which run applications, some of which may transmit packets to, and receive packets from, other hosts on the network 100. Hosts 105 may also be firewall machines.

Referring to FIG. 1, a typical multicast request scenario may include host machine 105a either issuing an asynchronous join request via IGMP for multicast content (IGMPv2), corresponding to multicast group address 227.0.0.1, or responding to an IGMP query from the LAN's 110 designated router¹ (DR) 101a. The designated router 101a will thus note that one of the hosts on its LAN 110 requires multicast data corresponding to address 227.0.0.1, and will issue join messages, or appropriate alternatives in accordance with the multicast protocol in operation, to its upstream neighbours 101b, etc. for this group address. (All multicast routers on the LAN 110 will store the same information relating to multicast groups, senders, receivers etc, but non-DR routers are passive, as they do not send IGMP queries or PIM join/prune messages). It may be that other hosts 105b, 105c on different LANs similarly request information corresponding to this multicast group, and there may be many paths extending between the source router 111, or Rendezvous Point (RP) router 112 and intended receivers 105a, 105b, 105c. (It is understood that a rendezvous point router is where multicast content is registered: this is relevant to PIM protocol only; for other multicast protocols the equivalent device is the router that the source is connected to—router shown as 111 in FIG. 1). ¹ A designated router, which is a router on a LAN which is responsible for sending multicast query messages, sends membership queries to the “All-hosts” multicast address to solicit which multicast groups have active receivers on the local network.

As routers are responsible for the replication of multicast data through the network, the path that the data takes is determined on a hop by hop basis, as is the data replication process. Thus if there is a problem with delivery of multicast data, then in order to identify the source of the problem, the routers making up the delivery path have to be identified. The hop by hop nature of multicast data transmission means that he delivery path can only be discovered incrementally, and present methods make such discovery a tedious task that is prone to error.

Embodiments of the present invention use the multicast forwarding state and multicast protocols to check the actual flow of multicast data through a router for a specified multicast group address. The outgoing interfaces of a router are checked to see whether any neighbouring multicast routers are using these protocols for the multicast stream; if not, only end hosts should be attached. If there are multicast neighbours, the forwarding sates and neighbours thereof are retrieved. This process is repeated for each such neighbour router until there are not more neighbours, thereby defining the end of the delivery path. Thus embodiments use the actual forwarding tables used by the routers and switches to deliver traffic, together with knowledge of how multicast routing protocols work and deliver data, in order to determine what information needs to be gathered from individual network elements. This is done at run time without requiring any pre-processing knowledge of network devices or configuration.

Path delivery apparatus 109 to effect the method may be stored on the hard disc drive of a host machine 105a (implementation details given later), for processing thereon. The method (described below) enables discovery of the delivery path of the live multicast stream in real time—for all paths to all receivers of group 227.0.0.1—using SNMP messaging to access a Management Information Base (MIB) that is stored on routers. SNMP, or Simple Network Management Protocol, is part of the known TCP/IP network software, and a Management Information Base (MIB) is a standard specifying the data items that a host, router or switch must keep, together with the operations allowed on each. SNMP is thus the protocol that enables information to be extracted from the MIB, and is known to those skilled in the art. For further details see RFC 2037/2737, Entity MIB, McCloghnie et al 1996/1999, published by IETF (available from http://www.ietf.org), or Understanding SNMP MIBs by David Perkisn, Evan McGinnis, Prentice Hall, 1^{st} edition (Dec. 3, 1996);

Method for tracing multicast delivery path

FIG. 2 shows a block diagram of the method of the present invention, which, as described above, can be run by path determining apparatus 109 installed on a host 105a of FIG. 1, with the precondition that all routers attached to networks to be managed are accessible to the path determining apparatus 109. In this embodiment, management of links between transmitting source and receivers corresponding to multicast address 227.0.0.1 is co-ordinated from a predetermined Rendezvous Point router (RP) 112 using the PIM SM multicast protocol, and at least one host on the LAN 110 has requested data from this group address.

In the following, each step is carried out by the path determining apparatus 109:

S 2.1 Connect to the default gateway 114 for the host 105a carrying the path determining apparatus 109 and send SNMP messages to the Multicast-MIB on the default gateway 114, which is a multicast router, requesting which protocols are in operation on the router for this multicast address 227.0.0.1. The protocol used to route the data corresponding to 227.0.0.1 will be stored in the Multicast MIB on the designated router 101a² for the relevant LAN 110. In he present embodiment, multicast data is routed using PIM-SM, so the Multicast MIB will have PIM-SM stored as the protocol used to route this data. ² Note that for every multicast group address, each of the multicast routers in a domain will store the network address of the corresponding RP

S 2.2 Send messages to the default gateway 114 to determine the network address of the rendezvous point router 112; the message causes a process to run at the default gateway 114 that listens for rendezvous point router announcements³, returning the rendezvous point router's announced network address; ³ The RP router issues PIM Auto_RP and Bootstrap messages, which are received by agents on routers and typically written to the PIM-MIB; these RP PIM-MIB entries are usually inaccessible to SNMP messages.

S 2.3 Disconnect from the default gateway 114;

S 2.4 Connect to the rendezvous point router 112;

S 2.5 Retrieve routing tables from the rendezvous point router 112;

S 2.5.1 Query the routing table for he multicast address 227.0.0.1 using an SNMP message in order to determine whether the rendezvous point router 112 is directly connected to the transmitting source or not. If it is not directly connected to the transmitting source, retrieve the network address of the previous hop that is listed in the multicast routing table.

S 2.5.2 Cache network address(es) of upstream routers in memory, preferably as a linked list;

S 2.5.3 Repeat S 2.5.1 and S 2.5.2, adding upstream router network addresses to the linked list, until the “previous hop” is directly connected to the transmitting source: called first hop router 111. (It is understood that in “one-hop routing”, a routing table contains pairs (N, R) where N is the IP address of a destination network, and R is the next hop. Router R specifies one hop along the path from R to the destination network N. When a router is directly connected to a network in which a target host is located, the corresponding routing table entry specifies that the router is “directly connected” to all addresses corresponding to this network address (for Ethernets the network N is typically A LAN)).

S 2.6 Retrieve first hop router 111 multicast protocol routing tables:

S 2.6.1 Request (via SNMP) PIM neighbour table from the first hop router 111, and filter entries into a list of neighbouring routers that are connected to valid outgoing interfaces of the first hop router 111;

S 2.6.2 Collect the IGMP (via SNMP) group table from the first hop router, specifying group address 227.0.0.1, in order to determine all directly connected hosts for group address 227.0.0.1. Search for any switches that are between the router and end host (described below, with reference to FIG. 3);

S 2.6.3 Cache network address(es) of neighbouring routers and end hosts (as appropriate) in memory, typically as another, or part of the same, linked list;

S. 2.7 Repeat steps S 2.6.1-S 2.6.3 for each of the neighbouring routers retrieved from PIM-MIB, adding network addresses of neighbours comprising each delivery path to the linked list, until each delivery path has been traced to all receivers;

S 2.8 Write data comprising the linked lists to a file (not shown).

Discovery of switches

When receivers have been identified at step S 2.6.2, an additional step, that of searching for switches between the receiver and the last router is carried out. This additional discovery is crucial for determining how many nodes on a LAN are actually receiving multicast data, and for determining whether that data was requested by each node or received due to shared bandwidth. It is also necessary for reducing unnecessary network down time: Consider the scenario of a host node located behind a switch on an Ethernet network, where the IP address of the switch has not been recorded to the network manager. If the host develops a fault, which affects other machines on the same network, then the network administrator is likely to disconnect all of the users on the network by disabling the corresponding router interface. If the switch had been recorded, however, then the network manager merely has to disconnect the port of the switch to which the host is connected.

The following steps, illustrated in FIG. 3, describe a means of discovering the presence of switches between a router and a receiver:

Is router Cisco™ router? If YES:

S 3.1 Inspect router MIB for Cisco Discovery Protocol™ (CDP) information. If the last router is a Cisco™ router, and the switch (if any) is a Cisco™ switch, there will be CDP information relating to the switch stored on the router. CDP is a media- and protocol-independent device-discovery protocol that runs on all Cisco™-manufactured equipment including routers, access servers, bridges, and switches. (It is understood that using CDP a device can advertise its existence to other devices and receive information about other devices on the same LAN or on the remote side of a WAN (Wide Area Network). These devices broadcast information about themselves to neighbouring devices via packets, which are stored on these devices for discovery via SNMP, or Telnet).

S 3.1.1 Retrieve CDP data and if required send SNMP messages to each of the devices that have registered CDP data on the router to retrieve various operating parameters.

S 3.1.2 If the last router is a Cisco™ router, but there are non-Cisco™ switches attached, then there will not be any CDP information available on the router relating to this switch. In this situation, access the Address Resolution Protocol (ARP) table on the router via SNMP, and filter out the Cisco™ Ethernet addresses corresponding to Cisco™ switches from the ARP table retrieved from the router. Inspect the filtered Ethernet addresses in the ARP in order to determine whether any addresses match a known device (router and/or switch) vendor Ethernet allocation.

S 3.1.3 If it does then issue SNMP messages to discover various operating parameters relating thereto, retrieving a forwarding table and an ARP table (described below), if available.

If the last router is not a Cisco™ router

S 3.2 Access the ARP table on the last router via SNMP and inspect the Ethernet addresses as described above at S 3.1.2, and retrieve data as described in S 3.1.3.

There may be more than one switch located between the last router and receiver (between the switch discovered according to the above and the receiver). This can be determined by retrieving the forwarding tables of any discovered switches and applying tests listed under S 3.1 and S 3.2 until all of the Ethernet addresses listed in the forwarding table correspond to end-hosts.

Information retrieved from MIBs when determining multicast path:

As shown in Table 1, while carrying out the method described in FIG. 2, SNMP messages may be sent to the MIB11, RFC 1213-MIB and/or the respective Multicast-MIB in order to gather traffic satistics relating to that router (Table 1 is a non-exhaustive list of information that can be requested from MIBs). In particular, if information is gathered relating to packet forwarding rate, this provides a means for performing router forwarding rate comparisons. Furthermore, there is preferably a means for monitoring SNMP data received, and comparing this with predetermined thresholds, such that alarms are automatically generated when the retrieved data falls below the threshold.

TABLE 1

| Information | Source of information |
|---|---|
| Multicast protocols enabled on router | Multicast-MIB |
| Source of Multicast content: | Multicast-MIB + |
| If Protocol PIM-SM then start at RP router and | protocol-specific MIB |
| work back towards the source | (PIM, DVMRP) |
| Else source is router that is connected to source | |
| host | |
| User Datagram Protocol (UDP) Port: | SNMP RFC 1157, |
| SNMP transmits messages using UDP transport | RFC 1901 |
| protocol; “port” relates to the transport layer | |
| (layer 4) access point to the application | |
| (application in this case the agent on router that | |
| handles SNMP requests) | |
| Designated Router (DR): | IGMP-MIB or PIM-MIB |
| Each router on a LAN will store the IP address | (if PIM enabled) |
| of the DR for that LAN. | |
| End-hosts attached to router: | IGMP-MIB |
| If a router's interface is IGMP enabled, then it | |
| must be transmitting and/or receiving multicast | |
| packets to and/or from end-hosts. | |
| Traffic statistics for router: | RFC1213-MIB, |
| e.g. CPU load, bits processed/s, packets | Multicast-MIB, |
| processed/sec, TTL for group address, packets | CISCO-CPU-MIB, |
| forwarded/s, length of time router has been in | Telnet |
| forwarding state etc. | |

Gathering data in this way therefore provides a proactive method of managing multicast traffic: the health of the routers is monitored in order to identify potential and/or actual overloaded nodes.

Collating Information gathered:

The information relating to routers that make up the delivery path is conveniently saved as structures and comprises the following:

struct mstat {

| | |
|---|---|
| char router[25]; | /*IP address of current router*\| |
| char up_neighbor[25]; | /*IP address of upstream neighbour*\| |
| char swit[50]; | /*IP address of switch attached to |
| | current router*/ |
| char port[20]; | /*port number used to receive SNMP |
| | requests (UDP port)*/ |
| char subnet[25]; | /*IP address of subnet (class A, B, C or |
| | D)*/ |
| char inif[3]; | /*interface identifier*/ |
| int branch; | /*branch path identifier for this router*/ |
| int level; | /*level identifier for this router (below |
| | transmitting source router)*/ |
| long cpu; | /*CPU load*/ |
| unsigned long uptime; | /*time that router has been in |
| | forwarding state*/ |
| int position; | /*used for display purposes*/ |
| int dx; | /*used for display purposes*/ |
| int dy; | /*used for display purposes*/ |
| int y; | /*used for display purposes*/ |

} value[100][100];
struct pimn {

| | |
|---|---|
| char inif[3]; | /*interface identifier: interface for |
| | which PIM is the multicasting protcol*/ |
| char neighbor[50]; | /*IP address of downstream neighbour - |
| | router that has sent a JOIN request*/ |
| char flag[5]; | /*indicates delivery of traffic (via shared |
| | (common) tree or source specific tree)*/ |

} pimn[100][25];

The delivery path is most effectively presented visually. The following structure comprises only the information required to identify devices, and their position in the delivery path. The structure variables are populated by data in the linked lists (summary of device data), and these are used to create a topological map of the delivery path:

struct coord {

| | |
|---|---|
| char node_type[5]; | /* device identifier: switch, router, receiver |
| | etc.*/ |
| char filepointer[50]; | /*IP address of router - used for a filename |
| | (IP.gif)*/ |
| int xa; | /* device x co-ordinate in display frame for |
| | router*/ |
| int ya; | /*device y co-ordinate in display frame for |
| | router*/ |
| int xb; | /*x co-ordinate for attached switch*/ IF |
| | APPROPRIATE |
| int yb; | /*y co-ordinate for attached switch*/ IF |
| | APPROPRIATE |

} display_map[100];

A particular example is shown in FIG. 4. The position of the routers is derived from the variables: branch, level, position, dx, dy and y that are defined within the structure mstat, as these variables are assigned topological values as routers are discovered. Clearly, once the complete delivery path for a particular multicast group address has been determined, these positions are scaled according to the maximum and minimum values. In a preferred embodiment, and as shown also in FIG. 4, the delivery path is displayed, together with operating statistics relating to a selected router.

The information relating to switches, and VLANs—i.e. non-multicast routing devices and receivers that are attached to outgoing interfaces of the router—is similarly stored in structures, e.g. for switches:

struct {

| | |
|---|---|
| char active[5]; | /*status of switch*/ |
| char name[25]; | /*Name of switch |
| char addresses[25]; | /*host IP address*/ |
| int portref; | /*switch port to which this address is attached*/ |
| char type[5]; | /*type of switch: vendor specific*/ |
| char uplink[25]; | /*upstream device address for this port etc.*/ |
| int xt; | /*used for display purposes*/ |
| int yt; | /*used for display purposes*/ |
| } catold[100][100]; | |

Switch forwarding table:
struct {

| | |
|---|---|
| char mac[25]; | /*Physical address (Media Access Control |
| | (MAC) seen by switch*/ |
| char port[5]; | /*port number through which packets for this |
| | MAC address were passed*/ |

} cam_table[500];

Conveniently, the switch structure includes position data, and this is linked in with the position variables of structure mstat such that when the path is viewed graphically, attached switches can also be displayed (not shown).

| For end hosts: | | |
|---|---|---|
| struct record { | | |
| unsigned long int ip; | | /*IP address of node*/ |
| | char mac[18]; | /*Physical address corresponding to IP |
| | | address*/ |
| | unsigned long int upstream; | /*IP address of first hop router or first |
| | | hop switch*/ |
| | unsigned long port; | /*Interface number on switch or router |
| | | to which the node is connected, |
| | | retrieved via SNMP interface tables for |
| | | routers or for switches (Cisco) */ |
| | int date; | /*Time stamp from OS*/ |
| | unsigned long int hub; | /* Flag indicating that node is connected, |
| | | or not, to a hub; flag takes different |
| | | values depending on whether node |
| | | relates to a end-host address that is not |
| | | connected to a hub; an end-host address |
| | | that is connected to a hub; a network |
| | | address; a broadcast address; a reserved |
| | | address etc */ |
| | int vlan; | /*logical segment to which this node is |
| | | connected*/ |

} arp;

Similar structures exist for VLANs, SNMP community names (i.e. MIB access levels), and active multicast group addresses, etc. and each is cross-linked with a related node (i.e. connected node etc.).

There is therefore a rich source of information relating to

the network devices that transfer packets from source to receivers,

the topology between receivers and designated router (or equivalent), and

receivers themselves.

FIG. 4 focuses on the delivery path itself, but there are many alternative and complimentary ways of displaying switch and/or receiver information.

Implementation

As described with reference to FIG. 1, path determining apparatus 109 to effect the method of the above embodiment may be loaded on a client terminal 105a. The apparatus 109 can be run by a user, for example a network manager or network administrator, to determine the path(s) taken between the source and receiver(s) of multicast data corresponding to a predetermined group address. The user enters data via a browser, which provides a form for the user to specify a request in a known manner. Referring to FIG. 5, stored within the client terminal 105a (e.g. on the hard disk drive thereof) is an operating control program 510 comprising an operating system 512 (such as Windows (TM)), a browser 514 (such as Netscape (TM)) and application 511a, designed to operate within the browser 514. The function of the operating system 512 is a conventional and will not be described further. The function of the browser 514 is to interact, in known fashion, with hypertext information 511a received from a server 520 via a LAN (the server 520 may be one of the hosts 105 shown in FIG. 1). In this embodiment the hypertext information may be an HTML form, which is displayed to a user. The user then enters various parameters and/or requests, and posts the form, in a known manner, to a co-operating program 511b; thus from 511a and co-operating program 511b comprise the path determining apparatus 109. This form essentially captures any parameters entered by a user and transfers them to the co-operating program 511b stored on the server 520. For further information see “Client/Server Programming with Java and Corba”, 2^{nd} Edition, R. Ofrali and D, Harkey, pp. 239-242. Typical parameters that are entered by the input HTML form include a list of Multicast Group Addresses for which the delivery path is to be traced.

The co-operating program 511b, having received the completed form 511a, acts on data in the form according to the method presented in FIG. 2. In order to send and receive information to and from routers as described above, the co-operating program 511b connects to each of the routers in the multicast delivery path shown in FIG. 1 in a known manner via sockets. Once the co-operating program 511b has carried out the method of the invention, the collated information (e.g. FIG. 3) is inserted into a reply HTML document and displayed to the user on the browser 514 as output form 511c.

It is understood that the use of HTML forms in this manner is inessential to the invention: an application to effect the method of the embodiment could be stored on the server as an applet, downloaded into the browser 514, and run within the browser 514 in a known manner. Alternatively the method could be embodied in a Windows™—based application loaded on the client terminal 105a.

The input HTML form 511a may also write data received from the form 511a to a configuration file 522 stored on the server 520. This is convenient if the co-operating program 511b is to be run several times during the day; in this situation data collected is stored in an output file 524, for subsequent display as required (i.e. it is not immediately posted to an output HTML form). The co-operating program 511b is written in the C-programming language and pre-configured with directory location of the configuration files and the directory location for the data records. When the co-operating program 511b is loaded on a unix server, it can be automatically run in response to requests for new multicast data. For example, co-operating program 511b may issue periodic SNMP messages to predetermined routers on the network (typically one router per LAN) to check for entries corresponding to new multicast group addresses. If a new address is detected from one of these routers, the co-operating program 511b may trigger the method described above, with reference to FIG. 2, substituting this detected router for the default gateway at step S 2.1.

Modifications

As described above, the client terminal 105a, from which the path determining apparatus 109 to effect the method of the invention is run, may be located anywhere in the network, providing it has access to all routers in the network domain. Thus it is conceivable that the apparatus 109 may be located on a LAN comprising hosts, none of which have requested multicast traffic corresponding to the group address of interest. Assuming routers proactively add their interfaces and/or issue JOIN messages upstream in order to establish themselves as part of the multicast path, the designated router will not have any information relating to this group address. In this situation a request for the corresponding multicast data may be issued from client 105a to trigger the designated router to issue joins (or its alternative) through the network.

Thus the method shown in FIG. 2 includes the following pre-processing events:

Upon receipt of Multicast group address via the HTML form 511a, the co-operating program 511b checks for the group address in designated router Multicast-MIB;

If there is no entry for this group address, co-operating program 511b issues an IGMP request. This will trigger the designated router to issue PIM protocol joins through the network, enabling the method of the invention to be processed as described above.

The default gateway 114 for client terminal 105a may not be a multicast router; thus in step S 2.1, co-operating program 511b would have to connect to different routers on the LAN in an attempt to find a multicast router.

With multicast routing, data may loop between routers and/or switches, Consider the following arrangement:

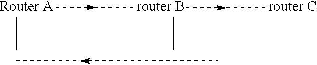

Routers B and C are determined to be direct neighbours of router A. After gathering information from router A, and before gathering information from router B, router C is already listed as a device to gather information from. Router A is then filtered out of the list of routers to be examined. Once information is gathered from B, it too is filtered out of the list of routers to be examined, and router C is accessed. At this point, the neighbours that C can detect (A and B) are now in the filtered list and will therefore not be probed a second time. This is known as loop avoidance. The embodiment described above maintains a list of probed routers, via a structure, and this list is referenced when a seemingly new neighbour is discovered, in order to determine whether or not to further probe the router for device information.

As described above, the network address of the rendezvous point router is determined by listening for rendezvous point announcements, as this information, although stored in PIM-MIB, is typically inaccessible to SNMP messages (determined by SNMP community name). Alternatively, a Telnet CLI function could be issued, requesting the rendezvous point's network address for the specified multicast group address. Unlike SNMP messages, which allow external devices direct access to MIB items, telnet requests are received and processed by internal router programs. These internal programs are therefore controlled by the vendor, and are able to access items in the MIB that are inaccessible to SNMP messages.

When multiple interfaces of a router are part of a multicast group delivery path, paths leading from each of the interfaces require to be traced in order to determine the complete delivery path. Each path could be traced independently, or each could be assigned a thread and the paths traced using multi-threading. Moreover, when the rendezvous point is not directly connected to the transmitting source, discovery of upstream delivery path is required (see step S 2.5). This upstream discovery process may also by multi-tasked with downstream path discovery.

The embodiment described above is concerned with transmission of multicast data, where the transmission is controlled via a registered router known as the rendezvous point (so the delivery path branches out into a shared tree from the rendezvous point). For some network configurations, this delivery path may not be the shortest—thus most efficient—path. If delivery efficiency is important, then, when routing data using PIM-SM, the routing protocol can create the shortest path and deliver data along this path instead of via the shared tree. Thus some receivers may receive data from the shared tree, and some via the shortest path. The PIM-MIB maintains a flag, which indicates the type of path delivery (see struct pimn above). Thus these shortest path receivers may not have received data via the rendezvous point, but directly from the router attached to the transmitting source. As such, when the directly connected router has been determined (step S 2.5 above), the method includes a further check for the routing flag in PIM-MIB. If the flag indicates routing of data via both shared tree and shortest path method, discovery of both paths is required.

When multicast data is routed by the MOSPF protocol, locating the transmitting source may require crossing between OSPF Areas, and may thus require locating border routers (BR) that serve as gateways between these areas⁴. In this situation, appropriate BR need to be identified so as to enable the apparatus 109 to locate the link area of the transmitting source. A border router for a given area can be identified from any router's forwarding table, as a forwarding table includes a destination type for each routing table entry—e.g. network, area border router, AS boundary router. Step S 2.5 can then be effected from any router within the identified area.

⁴ MOSPF is an extension of OSPF: routers maintain a link state database, which is populated by link state advertisements of link (interface) states. A description of a link (interface) would include, for example, the IP address of the interface, the mask, the type of network it is connected to, the routers connected to that network and so on. The collection of all these link-states forms a link-state database. This database is used by OSPF algorithm to route through an area of a network (network split into areas to reduce network traffic generated by link state announcements); routers that are gateways between areas are border routers.

When multicast data is routed by the DVMRP protocol, data is routed along delivery trees. Thus once the method has located a default gateway, it is only required to determine where the current router is in that particular branch of the delivery tree (i.e. if not at the source, continue upwards, when at source, trace downwards to all receivers).

The above embodiment describes tracing the multicast path for a single Multicast group addresses. However, many addresses may be entered via the form 511a, and the method may be effected either for each group address in turn, or concurrently using multi-threading techniques.

In large networks, the number of routers comprising branches of the multicast delivery path may be large, such that displaying of router configuration and discovery of switch configurations may be impractical. In this situation, the user may select, via the output form 511c, a start router and an end router within the determined multicast delivery path, and request the method of the invention to be effected again between these two points. In this situation, the method starts at step S 2.6, and the start router effectively becomes the rendezvous point. This provides data relating to a more limited selection of devices, and particularly where switch discovery is in operation, provides information on a more practical scale.

As will be understood by those skilled in the art, the invention described above may be embodied in one or more computer programs. These programs can be contained on various transmission and/or storage mediums such as a floppy disc, CD-ROM, or magnetic tape so that the programs can be loaded onto one or more general purpose computers or could be downloaded over a computer network using a suitable transmission medium.

1. A method of determining one or more paths through a communications network, which one or more paths are arranged to transmit data between at least one transmitting node and at least one receiving node, the method comprising the steps of:
(i) identifying a first network forwarding node that is in operative association with the transmitting node;
(ii) for each port of the first network forwarding node, determining a network address of a second network forwarding node to which the data has passed;
(iii) repeating step (ii) for each of the second and subsequently so determined network forwarding nodes, until a network forwarding node is determined to be directly connected to the at least one receiving node.

2. A method according to claim 1, in which the data corresponds to a multicast group address.

3. A method according to claim 2, in which step (i) comprises the steps of:
a) determining a network address of a predetermined network forwarding node, through which multicast data is registered;
b) obtaining a list of all nodes that are directly accessible via the predetermined network forwarding node;
c) determining whether the transmitting node is directly connected to the predetermined network forwarding node, and if so, assigning the predetermined network forwarding node to the first network forwarding node;
d) if not, identifying, from the list of directly accessible nodes, a next network forwarding node from which the transmitting node is accessible, and
e) repeating steps b)—d) until the transmitting node is determined to be directly connected to the said next network forwarding node, and assigning the said next network forwarding node to the first network forwarding node.

4. A method according to claim 2 or claim 3, in which the step (ii) of determining a network address of a second network forwarding node includes identifying a network address of a network forwarding node that has requested, via a port of the first network forwarding node, data corresponding to this multicast group address.

5. A method according to any one of claims 2 to 4, in which the step (iii) of determining that a network forwarding node is directly connected to a receiver includes obtaining, from the said network forwarding node, a list of directly connected receiving nodes.

6. A method according to any one of claims 2 to 5, further including the steps of
a) obtaining a first list of network addresses of all nodes that are accessible via the said network forwarding node for each node listed in the first list:
a11) categorising the node;
a12) if the categorised node corresponds to a switch network node, obtaining a second list, which second list comprises addresses that are accessible via the categorised node;
a13) repeating steps a11-a12 until all switch nodes that are accessible via the said network forwarding node have been identified.

7. A method according to any one of the preceding claims, further including retrieving, from the network forwarding nodes and/or the switch nodes, any one or a combination of
(i) packet forwarding statistics,
(ii) loading on network forwarding nodes and/or switch nodes, and
(iii) status of network forwarding nodes and/or the switch nodes.

8. A method according to claim 7, including monitoring the retrieved loading on network forwarding nodes and generating an alarm when the loading exceeds a predetermined threshold.

9. A method according to claim 7 or claim 8, in which information is so retrieved using a communications protocol.

10. A method according to claim 9, in which the communications protocol is the Simple Network Management Protocol.

11. Apparatus for determining one or more paths through a communications network, which one or more paths are arranged to transmit data between at least one transmitting node and at least one receiving node, the apparatus comprising:
(i) identifying means for identifying a first network forwarding node that is in operative association with the transmitting node;
(ii) determining means for determining a network address of a second network forwarding node to which the data has passed, for each port of the first network forwarding node;
(iii) means for repeating operation of the determining means (ii) for each of the second and subsequently so determined network forwarding nodes, the apparatus being arranged such that the means (iii) repeats operation of the determining means (ii) until a network forwarding node is determined to be directly connected to the at least one receiving node.

12. Apparatus according to claim 11, further comprising means for outputting a set of network addresses determined by the determining means for at least one path for transmitting data from the at least one transmitting node to a receiving node.

13. Path determining apparatus for use in determining one or more paths for multicast data through a communications network, the network comprising nodes connected by communications links,
at least a first of which nodes being provided with multicast routing data and multicast protocol data for use in routing multicast traffic over the network from a transmitting source to at least one receiving node,
wherein the path determining apparatus comprises means to access the multicast routing data and multicast protocol data and to retrieve information therefrom in determining the path from the transmitting source to the at least one receiving node.

14. A computer program comprising a set of instructions to cause a computer to perform the method according to any one of claims 1-10.
